(19) United States
(12) Patent Application Publication
(10) Pub. No.: US 2022/0363568 A1
(43) Pub. Date: Nov. 17, 2022

(54) DEVICES AND METHODS FOR MONITORING WATER TREATMENT AND FLOW

(71) Applicant: LITEWATER, LLC, Birmingham, AL (US)

(72) Inventors: Patrick KUNG, Vestavia Hills, AL (US); Mark ELLIOTT, Tuscaloosa, AL (US); Peyton FALKENBURG, Birmingham, AL (US); Benjamin BICKERSTAFF, Hoover, AL (US)

(21) Appl. No.: 17/769,972

(22) PCT Filed: Oct. 16, 2020
(86) PCT No.: PCT/US2020/056045

§ 371 Date: Apr. 18, 2022

Related U.S. Application Data
(60) Provisional application No. 62/923,218, filed on Oct. 18, 2019.

(51) Int. Cl. C02F 1/32; C02F 1/00

(52) U.S. Cl. CPC C02F 1/325; C02F 1/001; C02F 2201/326; C02F 2201/3225; C02F 2209/02; C02F 2209/40; C02F 2303/04

(57) ABSTRACT

Described herein is a networked smart device capable of transmitting water flow and quality data to a cloud database, in real-time. In some instances, the device is part of a broader ecosystem or platform comprised of one or more of the devices, associated software and data management. This type of platform enables data analysis of water intake and quality, for a variety of users. Physically, the device itself connects to a water outlet such as a sink faucet or refrigerator intake pipes, and is integrated/incorporated into a flow-through water disinfection reactor as well as a filtration mechanism. Additionally, flow sensors and antennas for wireless communications capability can be included to transmit the data. An accompanying software application and back-end database management allows device users to manage their data and track their water intake.

### CROSS REFERENCE TO RELATED APPLICATION

This application claims priority to and benefit of U.S. Provisional Patent Application No. 62/923,218 filed Oct. 18, 2019, which is fully incorporated by reference and made a part hereof

### FIELD

The present disclosure relates to devices and methods for monitoring water treatment and flow.

### BACKGROUND

Previous drinking water disinfection methods that protect users from pathogens have one or more of the following disadvantages: (1) they create unpleasant tastes and odors, (2) generate harmful disinfection by-products, (3) are incompatible with in-home use, (4) are expensive, and (5) are large and/or difficult to install and maintain. There is a need for a simple, compact, inexpensive, drinking water disinfection unit that can be easily installed on a faucet or water bottle and protects users from pathogens. This need exists both in the United States and in many settings around the world.

One example of a water filtering product includes the Brita™ products. However, there are several problems associated with this technology. First, these require frequent and expensive filter changes. Importantly, these filters do not provide disinfection of the water. Second, Brita™ products are useful for batches, but are not useful for continuous or flowing water samples. Another example of a water filtering product includes the SteriPEN™. While this product can disinfect water, it is only useful for small batches and thus cannot be used for flowing water samples. In addition, these drinking water disinfection methods still leave unpleasant tastes and odors, generate harmful disinfection by-products, are incompatible with in-home flow-through use, and are large and/or difficult to install and maintain.

Furthermore, there is no technology that enables and supports distributed water flow and quality data collection/monitoring after water is distributed out of a centralized location (e.g., municipality-owned). The data is currently heavily centralized—if existing at all. For example, there currently doesn't exist a mechanism to transmit quality data on water flow in real time to someone looking to track their water intake. Monitoring and collecting data at the local, consumption point provides valuable information for the consumer (health, safety). Additionally, data can be significantly valuable for monitoring/troubleshooting water distribution (rapid response, maintenance, planning, resource management).

Current technology is too big and bulky to integrate with existing infrastructure and comprehensively treat (filter and disinfect) water on a flow-through basis.

The devices and methods disclosed herein address these and other needs.

### SUMMARY

Described herein are embodiments of a networked smart device capable of transmitting water flow and quality data to a cloud database, in real-time. In some instances, the device is part of a broader ‘ecosystem’ or platform comprised of one or more of the devices, associated software and data management. This type of platform enables data analysis of water intake and quality, for a variety of users. Physically, the device itself connects to a water outlet such as a sink faucet or refrigerator intake pipes, and is integrated/incorporated into a flow-through water disinfection reactor as well as a filtration mechanism. Additionally, flow sensors and antennas for wireless communications capability can be included to transmit the data. An accompanying software application, which may include applications at least partially executing on a mobile device such as a smart phone, tablet, laptop computer and the like, and back-end database management allows device users to manage their data and track their water intake.

Other systems, methods, features and/or advantages will become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The accompanying figures, which are incorporated in and constitute a part of this specification, illustrate several aspects described below.

FIG. 1 shows a cross-sectional diagram illustrating an example of a UV-lamp device for the disinfection of a flowing water sample. FIG. 1 is further described in Example 1.

FIG. 2 shows an illustration of the type of 3D optical simulations of a UV lamp water reactor. FIG. 2 is further described in Example 3.

FIG. 3 shows a schematic of an example of a spiral UV lamp device for the disinfection of a flowing water sample. The UV lamp is shown split into two, where the smaller spiral is dimensioned so as to fit into the larger spiral.

FIG. 4 shows a schematic of an example of a spiral UV lamp device for the disinfection of a flowing water sample, where the smaller spiral is shown to fit into the larger spiral.

FIGS. 5A-5D are three-dimensional renderings of an device comprising a compact, modular, self-contained ultraviolet device for the inactivation of a pathogen in a flowing water sample that further includes filtration and at least one processor, sensors and a communications interface in communication with the processor.

FIG. 6 is a block diagram of the device shown in FIGS. 5A-5D.

FIG. 7 is an illustration of a system comprised of one or more of the devices shown in FIGS. 5A-5D and FIG. 6, where each device is installed and connected to a water outlet (faucet, refrigerator, etc.) in a home, business or other location of potable water usage.

FIGS. 8A-8N illustrate an exemplary embodiment of a compact, modular, self-contained ultraviolet device for the inactivation of a pathogen in a flowing water sample and filtering comprised of multiple stages and having replaceable components.

FIG. 9 illustrates an exemplary computer according to aspects of the disclosed embodiments.

### DETAILED DESCRIPTION

The present disclosure relates to device, systems and methods of monitoring water treatment and flow.

As used in the specification and the appended claims, the singular fowls “a,” “n” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

In one aspect. disclosed herein is a compact flow-through device that can be used for the disinfection of a flowing water sample using ultraviolet light. The ultraviolet (UV) lamp is in direct contact, or in close contact, with the flowing water sample and the UV lamp is enclosed in a highly reflective cavity, allowing higher flow rates and minimizing the optical losses. In addition, the devices disclosed herein deliver the ultraviolet light radially both inward and outward, which allows the outward rays to already participate in water disinfection even before they are reflected by the highly reflective cavity (i.e. an aluminum surface). The devices disclosed herein are useful in methods for the disinfection of water, and are useful for the inactivation of pathogens in flowing water samples.

Previous drinking water disinfection methods leave unpleasant tastes and odors, generate harmful disinfection by-products, are incompatible with in-home flow-through use, are expensive, or are large and/or difficult to install and maintain. Disclosed herein is a compact and inexpensive flow-through device that can be used for the disinfection of a water sample using ultraviolet light.

Reference will now be made in detail to the embodiments of the invention, examples of which are illustrated in the drawings and the examples. This invention may, however, be embodied in many different forms and should not be construed as limited to the embodiments set forth herein.

Unless defined otherwise, all technical and scientific terms used herein have the same meaning as commonly understood to one of ordinary skill in the art to which this invention belongs.

The technology herein possesses a new optical configuration that enables residential point-of-use/point-of-entry drinking water treatment that (1) provides an economical option to treat water at the household and dispenser level over centralized drinking watersystems, (2) at market attractive flow rates, and (3) that meet EPA drinking water standards, none of which are achieved by current product offerings.

A UV disinfection treatment device that is affordable, chemical-free, pathogen-free in a user-friendly form factor will benefit people by protecting them from waterborne disease and from the disinfection by-products generated by chemical disinfectants. This in turn reduces exposure to pathogens in the environment therefore impacting people and prosperity.

UV disinfection precludes the use of chlorine for wastewater treatment, and the discharge of chlorine and its by-products to waterways are covered under the Clean Water Act. Drinking water treatment protects human health and is covered under the Safe Drinking Water Act. Due to their known and potential health effects, the EPA regulates the presence of disinfection byproducts (DBPs) in drinking water under the Stage 1 and Stage 2 Disinfection/Disinfection Byproducts Rules implemented in 2001 and 2006, respectively. The disinfection byproducts of note include, for example, the four trihalomethanes (THMs): trichloromethane (or chloroform), bromodichloromethane, dibromochloromethane, and tribromomethane (or bromoform). The EPA regulates trihalomethanes because prolonged consumption above the maximum contaminant level of 0.08 mg/L can cause various cancers.

### Water Treatment

America's water distribution systems are overtaxed and in severe need of repair. Many of the metal pipes that comprise these systems have exceeded their useful life; many have been in use for over a century, with some even predating the Civil War. Over time the pipes have become brittle and begun to easily break. In fact, according to the EPA, there are 240,000 water main breakages per year. Unfortunately, fixing this problem with renovations isn't as simple as just digging up and replacing the pipes. With over 1 million miles of pipes currently in place, the replacement process will be lengthy and expensive. In addition to those using public piped water, more than 30 million Americans still use untreated well water as their primary water source. Also, many communities in developing countries cannot provide safe drinking water to the home. For example, in India and China, hundreds of millions of people have gained access to piped water since 1990, but the water is typically unsafe to drink (WHO and UNICEF (2015). Progress on Sanitation and Drinking Water: 2015 Update and MDG Assessment. Geneva: World Health Organization; Kumpel, E., & Nelson, K. L. (2014). Environmental science f technology. 48(5), 2766-2775). Additionally, unsafe sanitation, including nearly 900 million people defecating in the open (WHO and UNICEF, 2015), can contaminate the ground and lead to the widespread contamination of water sources and occurrence of waterborne diseases. Disclosed herein is a UV lamp containing device that can provide consumers with microbiologically safe drinking water through an efficient point of use (POU) device. In comparison, activated carbon filters, such as in Pur and Brita filters, which are very common amongst consumers, do not remove harmful microbiological pathogens (viruses and bacteria), such as E. coli.

In the United States, waterborne disease is still a major threat to the elderly, immuno-compromised, the very young, and those with gastrointestinal diseases (e.g., Crohn's disease). The EPA and CDC estimate contaminated public water systems account for 13 million annual cases of water borne illnesses in the US. These cases result in 240,000 hospitalizations per year with annual costs of $937 million. Water treatment and reuse using instant-on/off capable UV lamps with intensity sensors (flow sensors) has many advantages over other disinfection methods, including, for example: energy efficiency, lightness and portability, no formation of disinfection byproducts, low heat generation, and the potential for very low cost.

The previous continuous flow devices available are very expensive and aimed at commercial use rather than in home use. These products are not economically viable for the residential consumer market. More consumer-friendly UV systems are expensive and utilize what is known as “batch” treatment. Batch treatment must first collect the water in a container, such as a pitcher or bottle, and then shine the UV treatment on the whole batch. These products process very little water, have high upfront costs, and are not convenient for residential consumer use.

### Device and Methods

Disclosed herein is a compact flow-through device that can be used for the disinfection of a water sample using ultraviolet light.

In one aspect, provided herein is a device for inactivation of a pathogen in a flowing water sample, the device comprising:

a housing container, wherein the housing container comprises a highly reflective cavity;

an ultraviolet lamp, wherein the ultraviolet lamp is comprised within the housing container;

an entry point and exit point for a flowing water sample, wherein the flowing water sample is

in direct contact or in close contact with the ultraviolet lamp; and

wherein the ultraviolet lamp delivers ultraviolet light rays both radially inward and outward.

In another aspect, provided herein is a method for inactivating a pathogen in a flowing water sample, comprising:
subjecting a flowing water sample to a device, the device comprising:
   a housing container, wherein the housing container comprises a highly reflective cavity;
   an ultraviolet lamp, wherein the ultraviolet lamp is comprised within the housing container;
   an entry point and exit point for a flowing water sample, wherein the flowing water sample is in direct contact or in close contact with the ultraviolet lamp; and
wherein the ultraviolet lamp delivers ultraviolet light rays both radially inward and outward for inactivating a pathogen.

In one embodiment, the device further comprises a flow sensor (7), wherein the flow sensor (7) indicates the amount of an ultraviolet light dose provided to the flowing water sample. In one embodiment, the device further comprises a highly reflective material lining the housing container.

In one embodiment, the device further comprises a protective coating over the highly reflective material.

In one embodiment, the ultraviolet lamp is a low pressure, medium pressure, or high-pressure mercury lamp. In one embodiment, the ultraviolet lamp is a cold cathode lamp. In one embodiment, the ultraviolet lamp is a UV LED. In one embodiment, the ultraviolet lamp is a UV laser light source.

In one embodiment, the flow sensor (7) is a visible light. In one embodiment, the flow sensor (7) is a digital representation. In one embodiment, the flow sensor (7) is an LCD display. In one embodiment, the flow sensor (7) is a dial.

In one embodiment, the method kills greater than 99% of pathogens in the flowing water sample. In one embodiment, the method kills greater than 99.9% of pathogens in the flowing water sample. In one embodiment, the method kills greater than 99.99% of pathogens in the flowing water sample.

In one embodiment, the flowing water sample is in direct contact with the ultraviolet lamp. In one embodiment, the flowing water sample is in close contact with the ultraviolet lamp.

In some embodiments, the device disclosed herein can treat 5 liters per minute (1.32 gallons per minute) at a dose of 80 mJ/cm² and achieves 99.99% (4-log) inactivation of MS2 virus as it flows out from the water-dispensing source. The National Sanitation Foundation International (NSF International) required dose for its most stringent (Class A) POU UV treatment standard is 40 mJ/cm²; the present device can achieve twice this dose.

In some embodiments the water flow rate is about from about 2 L/min to about 10 L/min). In one embodiment, the water flow rate is about 2 L/min. In one embodiment, the water flow rate is about 5 L/min. In one embodiment, the water flow rate is about 10 L/min.

This device can be used, for example, on a household water-faucet. This device can also be used, for example, to disinfect water flowing into a liquid container (for example, water bottle). The device can be used alone or in conjunction with in-line carbon filtration. In some embodiments, the device can achieve at least 4-log₁₀ (99.99%) reduction of MS2. In some embodiments, the flow rate of the water is up to 5 L/min.

In some embodiments, the flowing water sample is passed through one UV lamp containing device as disclosed herein. In some embodiments, the flowing water sample is passed through at least two UV lamp containing devices as disclosed herein (for example, at least two, at least three, at least four, at least five, etc.).

Benefits of the invention disclosed herein can include, but are not limited to: point-of use drinking water treatment, eliminates pathogenic bacteria and viruses, does not need chlorine or other chemicals, allows continuous flow capability, is small and compact, and is also easy to install.

### Ultraviolet (UV) Lamps

A number of UV lamp types can be used in the current device to provide a source of ultraviolet light. In some embodiments, the UV lamp is selected from a UV LED, a UV laser, a secondary process generated UV light (e.g. photoexcited phosphors), or high/low pressure mercury lamp including cold cathode lamps (CCL).

Water treatment and reuse using instant-on/off capable UV cold cathode lamps with intensity sensors has a number of advantages over other disinfection methods, including: energy efficiency, lightness and portability, no formation of disinfection byproducts, low heat generation, and the potential for very low cost. These advantages make potential markets for UV cold cathode disinfection vast and diverse, particularly for point of use and point of entry devices and applications in developing countries.

Disinfection measurements can include, for example, (1) 4-log MS2 virus reduction the EPA standard for complete treatment of viruses in groundwater (USEPA, 2006), (2) the 40 mJ/cm² NSF 55A dose standard (NSF International, 2004), and (3) the 186 mJ/cm² EPA standard to receive complete virus inactivation log-reduction credit from UV alone in drinking water utilities (USEPA's Office of Water, Carollo Engineers, Malcolm Pirnie, The Cadmus Group, Karl G.Linden, and James P. Malley Jr. (2006) “Ultraviolet Disinfection Guidance Manual For The Final Long Term 2 Enhanced Surface Water Treatment Rule.” United States Environmental Protection Agency. Washington, D.C.).

Cold cathode lamps have been used in batch systems for UV disinfection of drinking water, but are not currently used in flow-through systems. These systems provide for disinfection of drinking water, wastewater, recycled water and other environmental media and surfaces. Application to point of use devices are especially appealing due to the energy efficiency, lightness, potential low cost, no formation of disinfection byproducts, low heat generation, and other advantages.

In the United States, waterborne disease is still a major threat to the elderly, immunocompromised, the very young, and those with gastrointestinal diseases (e.g., Crohn's disease); The CDC estimates 19.5 million cases of waterborne disease from public systems (Reynolds K A, Mena K D, Gerba C P. (2008). Rev Environ Contam Toxicol. 192:117-158) and this does not include the waterborne disease risk of the 30 million Americans relying on untreated private well water is unknown. Many communities in developing countries cannot provide safe drinking water to the home. For example, in India and China, hundreds of millions of people have gained access to piped water since 1990, but the water is typically unsafe to drink (WHO and UNICEF (2015). Progress on Sanitation and Drinking Water: 2015 Update and MDG Assessment. Geneva: World Health Organization; Kumpel, E., & Nelson, K. L. (2014). Environmental science & technology, 48(5), 2766-2775). Of course, in many communities, piped water infrastructure is non- existent and available sources are unsafe to drink without treatment (Bain, B. J. (2015). Blood cells: a practical guide. John Wiley & Sons). Additionally, unsafe sanitation, including nearly 900 million people defecating in the open (WHO and UNICEF, 2015), can contaminate the ground and lead to the widespread occurrence of waterborne diseases. Point of use drinking water treatment provides a possible solution to these problem (Sobsey, M. D., et al. Environmental science & technology 42(12), 4261-4267).

Point of use UV disinfection systems have been successfully implemented in some settings (Gruber, J. S et al. (2013). The American journal of tropical medicine and hygiene, 89(2), 238-245; Reygadas, F., et al. (2015). Water research, 85, 74-84). However, these systems are large and impractical for faucet-based use or they are expensive with complicated plumbing installation. Cold cathode UV disinfection systems provide a compact, economical way to inactivate waterborne pathogens at the tap.

Some of the benefits of using a cold cathode lamp include: it turns on instantly, it has high-wall plug efficiency, it has a high output, and also is a long-lasting lamp. In addition, the cold cathode lamps are relatively inexpensive, can be used in a flexible configuration, and are compact.

A further method of water treatment uses UV LED (light emitting diode) light for water treatment. The use of UV LED light has the advantage of being able to use a wider UV band with multiple LED wavelengths, can offer a high-power output with less power consumption than UV lamps, UV LEDs have greater longevity, power up quickly without requiring a delay time built into the system for the UV light source to reach its optimum UV energy output, and do not contain mercury. In some embodiments, UV LEDs can be used as the UV light source. However, one current drawback of UV LEDs is that they can be expensive.

UV lamps can be, for example, low pressure, medium pressure, and or pressure UV germicidal lamps.

In some embodiment, the UV lamp or UV light source is a UV laser. In some embodiments, the UV laser is capable of providing a UV laser light energy that is significantly more powerful than a conventional UV lamp.

In some embodiments, the device can incorporate the use of multiple UV lamp technologies such as LED, laser, fluorescent, excimer, incandescent, cold cathode, hot cathode, and others.

The most common mechanism of UV disinfection is through absorbance by DNA and RNA and the formation of pyrimidine dimers that prevent organisms from replicating; absorbance of UV light by nucleic acids peaks around 254-nm (EPA's Office of Water, 2006). In some embodiments, the UV wavelength ranges from, for example, in the 100 nm to 450 nm. The measurement wavelengths can include, for example, about 100 nm, about 150 nm, about 200 nm, about 250 nm, about 300 nm, about 350 nm, about 400 nm, or about 450 nm.

In some embodiments, the device comprises a spiral-shaped UV-light source. In some embodiments, the UV light source is comprised in two spiral shapes. In some embodiments, the UV light source is comprised in at least two spiral shapes. In some embodiments, the UV light source comprises a smaller spiral UV lamp dimensioned to fit within a larger spiral UV lamp.

In some embodiments, the parameters of UV lamp can be adjusted for the size of a liquid container (for example, a water bottle). In some embodiments, based on the bottle neck entrance being 1.25″ or −31 mm diameter, the inner spiral has a diameter of about 13.5 mm; the outer spiral has a diameter of about 16.5 mm; the inner and outer coil are attached at the bottom; the electrical connections can be at the top, vertical, parallel, or on opposite sides so that the lamp is held evenly; and the number of spirals can be two or more. However, the devices disclosed herein are dimensioned so as to fit onto the top of a water bottle, and the size ranges for the spiral UV lamps can be adjusted by one of skill in the art to fit various sized bottles or containers. Nonlimiting examples of water bottles include Nalgene bottles and Swell bottles.

In some embodiments, the device disclosed herein is funnel shaped. In some embodiments, the device may be fitted onto a water bottle via an adaptor. In some embodiments, the device may be fitted onto a container, water bottle, thermos, canteen, or other device used as a liquid (for example, water) container. In some embodiments, the adaptor can be funnel shaped. Using various sized adaptors, the devices disclosed herein can be fitted to any number of differently shaped water bottles. In some embodiments, the device may contain threads to screw onto the threads of a thermos, bottle, or container.

As consumers become increasingly health conscientious, they are looking for new and easy methods for filtering and/or disinfecting their water. The devices and methods disclosed herein provide a convenient method for disinfecting water for any sized thermos or water bottle.

### Housing Container and Highly Reflective Cavity

The UV lamp of the device is comprised within a housing container. The housing container can also be referred to as a water flow chamber. The housing container provides protection of a consumer from the ultraviolet light rays, and also provides a highly reflective cavity to reflect the ultraviolet light rays to provide increased efficiency for the disinfection and the inactivation of pathogens in the water sample. In some embodiments, the lamp is submerged in the highly reflective cavity.

In some embodiments, the housing container is made of a metal. In some embodiments, the housing container is made of aluminum.

In some embodiments, the highly reflective cavity is provided by the housing container itself. For example, the housing container can be made of a metal, such as aluminum, which provides a highly reflective surface to reflect the UV light rays from the UV lamp.

In some embodiments, the highly reflective cavity can be provided using a highly reflective material to line the housing container.

In some embodiments, a thin protective coating can be applied, in order to help prevent oxidation of the highly reflective coating, which can occur due to the contact with the water.

### Flowing Water Samples and Methods of Use

In some embodiments, the UV device can be used to disinfect a flowing water sample. For example, the UV device could be used for disinfection in flowing water samples from a faucet or a sink, in a refrigerator, or in water fountains. In some embodiments, the devices herein can be used for disinfection of a flowing water sample into a liquid container (thermos, water bottle, and the like).

There are over 30 million private well users. Most of the water from these wells receives no treatment for disinfection. There are over 3 million faucets in homes with newborns. Newborns require contaminant free water to mix with baby formula. In addition, as consumers become more health conscientious, the present invention provides them with a suitable at-home solution for improved water quality and disinfection.

In one aspect, provided herein is a method for inactivating a pathogen in a flowing water sample, comprising:
subjecting a flowing water sample to a device, the device comprising:
   a housing container, wherein the housing container comprises a highly reflective cavity;
   an ultraviolet lamp, wherein the ultraviolet lamp is comprised within the housing container;
   an entry point and exit point for a flowing water sample, wherein the flowing water sample is in direct contact or in close contact with the ultraviolet lamp; and
wherein the ultraviolet lamp delivers ultraviolet light rays both radially inward and outward for inactivating a pathogen.

In one embodiment, the device further comprises a flow sensor, wherein the flow sensor (7) indicates the amount of an ultraviolet light dose provided to the flowing water sample. In one embodiment, the device further comprises a highly reflective material lining the housing container. In one embodiment, the device further comprises a protective coating over the highly reflective material.

In one embodiment, the ultraviolet lamp is a low pressure, medium pressure, or high-pressure mercury lamp. In one embodiment, the ultraviolet lamp is a cold cathode lamp. In one embodiment, the ultraviolet lamp is a UV LED. In one embodiment, the ultraviolet lamp is a UV laser light source.

In one embodiment, the method kills greater than 99% of a pathogen in the flowing water sample. In one embodiment, the method kills greater than 99.9% of a pathogen in the flowing water sample. In one embodiment, the method kills greater than 99.99% of a pathogen in the flowing water sample.

### Flow Sensor

In some embodiments, the device comprises a flow sensor (7). This flow sensor (7) can be useful, for example, for in-home use conditions, to enable the user to identify when the UV light is working. In some embodiments, the flow sensor (7) can also provide for the amount of UV light administered to the water sample. For example, the amount could be shown by a digital display or based on a dial representing the amount of UV light administered. In addition, a UV intensity sensor that can be used to monitor and control lamp output and that are compatible with an inexpensive, faucet-based commercial unit are also disclosed herein.

In one embodiment, the flow sensor (7) is a digital representation. In one embodiment, the flow sensor (7) is an LCD display. In one embodiment, the flow sensor (7) is a dial. In one embodiment, the flow sensor (7) is an LED (light emitting diode) bar indicator. In one embodiment, the flow sensor (7) is a visible light.

### Pathogens

Various infectious agents are associated with human waterborne diseases, including for example, Campylobacter, E. coli, Leptospira, Pasteurella, Salmonella, Shigella, Vibrio, Yersinia, Proteus, Giardia, Entoamoeba, Cryptosporidium, hepatitis A virus, Norwalk, parvovirus, polio virus, and rotavirus. The most common bacterial diarrheal diseases on a worldwide basis are associated with waterborne transmission of Shigella, Salmonella, pathogenic E. coli, Campylobacter jejuni, and Vibrio cholera.

The UV devices and methods disclosed herein can be used against any of the above pathogens, or any other pathogens of interest that are susceptible to disinfection by UV light.

In one testing example, the viral surrogate MS2 is used as an indicator of UV efficacy; it is the most UV-resistant known virus surrogate (Hijnen, W. A. M. et al. (2006). Water research, 40(1), 3-22). The MS2 virus is widely preferred as an indicator of UV treatment effectiveness because E. coli and all other known vegetative bacteria are much more sensitive to UV than MS2 virus; likewise, with the common protozoan parasitic pathogens Cryptosporidium and Giardia. Many harmful pathogens, such as the ones above, can enter drinking water distribution pipes and travel untreated to household faucets by way of infiltration from leaks or breakages in the water system. In some embodiments, the MS2 reductions are seen at different flowrates (for example, 2 L/min, 5 L/min and 10 L/min).

### EXAMPLES

The following examples are set forth below to illustrate the devices, methods, and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

### Example 1

### Pathogen-Inactivating Ultraviolet (UV) Device

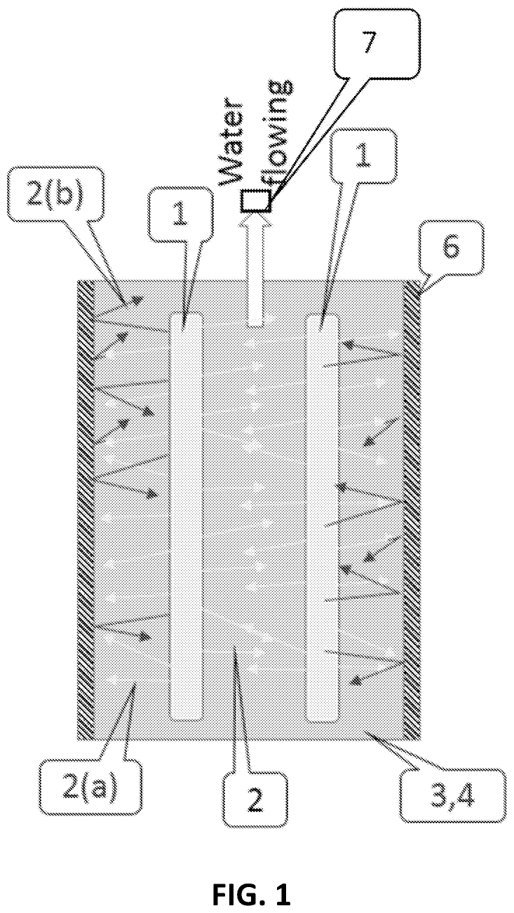

In this example, a pathogen-inactivating UV device is disclosed according to the schematic shown in FIG. 1. In the embodiment according to this example, the device is comprised of:
1) An ultraviolet light source;
2) The useful ultraviolet light is delivered radially both inward and outward. This allows the outward rays 2(a) to already participate in water disinfection even before they are reflected by the aluminum surface. These outward rays are then reflected back (2(b)) and participate again in water disinfection on their way inward;
3) This method is in such a manner that the light source is submerged in flowing water;
4) There is no need for a fused quartz tube, because the water is in direct or very close proximity to lamp;
5) This set up minimizes optical losses and allows higher flow rates while maintaining sufficient dose (optical power density*exposure time) of UV rays for effective disinfection;
6) The highly reflective cavity (for example, the aluminum tube) forms the wall of the housing container (also referred to as the “water flow chamber”).

### Example 2

### Microbiological Methods

Preparation of challenge organism stocks and enumeration of all samples are based on established and documented practices. For virus challenges, EPA Method 1602, Male-specific (F+) and Somatic Coliphage in Water by Single Agar Layer (SAL) Procedure (USEPA, 2001) are used. Appropriate control samples are used in each experiment and are shielded from ambient light. Complete mixing of original samples and dilutions are ensured through vortexing. All samples are exposed to UV light by one team for consistency, with microbiological analysis conducted and reported by two teams whenever possible. Five aliquots of each virus sample are collected, with two for immediate analysis and three frozen at −80 C for subsequent analysis if an assay fails or a result requires confirmation.

Other microorganisms are also tested with the UV devices. E. coli bacteria were tested in a flow-through experiment, but the E. coli are too sensitive. In the first challenge experiment, over 7-log₁₀ (99.99999%) were killed during an exposure of less than 0.2 seconds. E. coli and all other known vegetative bacteria are much more sensitive to UV than MS2; likewise with the common protozoan parasitic pathogens Cryptosporidium and Giardia. Viruses are the major challenge for UV disinfection. Therefore, the most robust surrogate for pathogenic viruses (MS2 ) (Hijnen, W. A. M, et al. (2006). Water esearch. 40(1), 3-22) can be used in all exposure experiments.

### Example 3

### Exposure Testing Apparatus

Proper measurement techniques for the UV irradiation characteristics are necessary. These were carried out using established methods, including using NIST traceable power meter coupled to a UV-enhanced photodiode, a spectrograph coupled to a UV-enhanced CCD and UV holographic grating for precise measurement of emission source spectra. Uniformity of exposure is determined by using a UV optical fiber coupled to either the photodiode/power meter or the spectrograph and mapping the desired area

Finally, parameters such as optical power loss at any additional optics components used (e.g. UV aluminum mirrors), optical reflection at the water surface, sample depth and thus absorption through the body of liquid, are accounted for in order to establish the exact dose received by the sample.

To enhance the UV dose available for inactivation, the lamps can be encapsulated in a highly reflective cavity (for example, aluminum), which—unlike glass mirrors—has high reflectivity in the germicidal UV range and prevents the useful UV light from being lost.

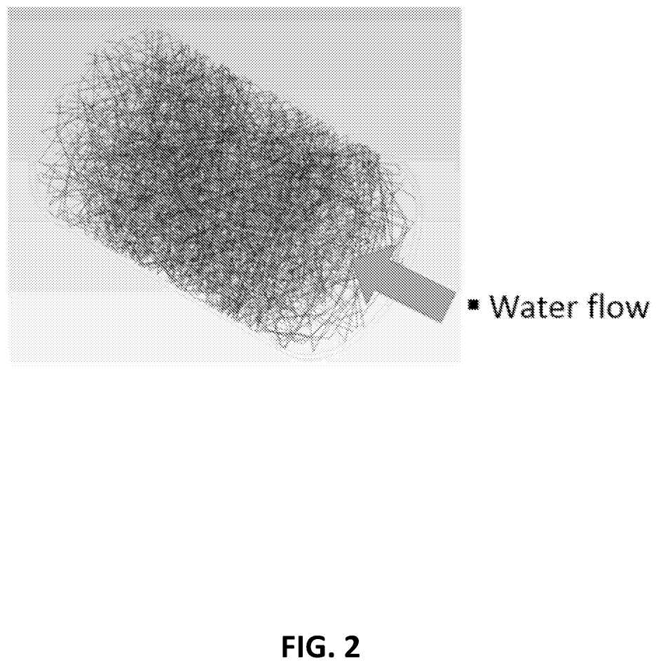

To further enhance the UV disinfection, additional changes were made to allow a higher flow rate by optimizing the UV exposure. In this example, the water is brought in closer contact with the UV light. Such a design is guided by 3D optical simulations (FIG. 2) that have been developed. Data have revealed that the diameter of the water reactor can be increased, which concurrently increases the total flow rate by 2× to 3× without sacrificing exposure dose. FIG. 2 is an illustration of the type of 3D simulations of a UV lamp water reactor. This device is more transportable and features a “plug-and-flow” capability allowing for simple point of use installation.

### Example 4

### Viral Indicators of UV Effectiveness

In this example, the viral surrogate MS2 is used as an indicator of UV effectiveness; it is the most UV-resistant known virus surrogate (Hijnen, W. A. M., et al. (2006). Water research, 40(1). 2). MS2 is an icosahedral, positive-sense single-stranded RNA bacteriophage (a virus that infects bacteria) that is widely preferred as an indicator of UV treatment effectiveness because its low susceptibility to UV is similar to that of adenoviruses (the human pathogenic viruses most resistant to UV) (Hijnen, W. A. M., et al. (2006). Water research, 40(1), 3-22). As noted above, the lamp kills bacteria too quickly to make E. coli or other challenge bacteria experimentally useful, under the present conditions.

In this example, the inactivation rates of MS2 viral indicators are determined in drinking water using a UV lamp with a flow rate of 5 L/min. The dose required to achieve the EPA standard of 4 log₁₀ reduction (99.99%) of MS2 virus is then determined. For the viral challenge, the test organism is a strain of the MS2 virus.

Samples are collected using sterile autoclavable bottles. Five aliquots of each virus sample are collected, with two for immediate analysis and three frozen at −80 C for subsequent analysis if an assay fails or a result requires confirmation. Microbial concentrations in the water are evaluated before and after exposure to UV and log₁₀ reductions calculated; the MS2 are evaluated using EPA Method 1602 (EPA, 2001).

In another example, a UV dose of 40 mJ/cm² (based on the known inactivation-to-dose relationship of MS2 virus; see Hijnen, W. A. M., et al. (2006). Water research, 40(1), 3-22) is used in drinking water using a counter-top fixed UV lamp with a flow rate of 10 L/min. 40 mJ/cm² is the standard NSF 55A dose for UV devices, the most rigorous UV standard from NSF International (NSF International, 2004). The above flow rate and dose can achieve the EPA standard of 4 log₁₀ reduction (99.99%). Challenge tests are conducted as described above.

In another example, a 2 L/min flow is achieved and a dose of 186 mJ/cm² (based on the known inactivation-to-dose relationship of MS2 virus; see Hijnen, W A M , et al. (2006). Water research, 40(1), 3-22). 186 mJ/cm² is the required dose for centralized water treatment facilities to receive full virus reduction credit solely through UV (USEPA et al., 2006). The testing protocol is identical as described above, except for the flow rate.

In another example, the reactor is modified based on the 3D optical modeling. This example includes integrating a few keys degrees of user-autonomy to the UV lamp setup by implementing electronic means to monitor and report in real-time the optical output of the lamp, and therefore be able to switch off the water flow if the UV source is no longer efficient for inactivation.

To measure the amount of UV light emitted by the lamp in the water reactor, an ultraviolet sensitive photodiode is used that provides the ability to quantify the amount of UV light emitted. The UV sensor (or flow sensor) is fixed in the water reactor and hermetically sealed. The electronic circuitry drives the sensor, amplifies the output electrical signal, and calibrates it so that the actual optical output of the lamp can be displayed on a small 4-digit liquid-crystal display (LCD) display (or a simpler demonstration could be using a small light emitting diode (LED) bar indicator). Not only would this let a user have a real-time measurement of the output power of the lamp, it enables two longer-term benefits: if the lamp output is below threshold, the system could be able to stop the flow of water by using an electronically-actuated valve; additionally, the user would be able to have a more quantitative measure of water transparency.

MS2 reductions under three flowrates (2, 5 and 10 L/min) are examined, with at least three replicate experiments. The consistency of results is evaluated as measured by less than 20% variation in log reductions across three replicates at each flow rate.

Long-term outcomes are focused on impacting health and well-being by protecting consumers from pathogens in drinking water.

This UV lamp embodies the three principles of sustainability, i.e. environmental, social, and economic criteria. First, the development of UV disinfection system will benefit the environment through the improvement of water quality and energy efficiency. UV lamps will greatly increase the water quality by decreasing the number of pathogens in the water. In addition, the UV lamp (for example, the cold cathode lamp) can lead to reduced carbon emissions through greater energy efficiency.

Then, the development of UV disinfection system is beneficial for people by protecting them from waterborne disease. Moreover, UV disinfection systems eliminate the use of chemicals and the production of carcinogenic by-product. Thanks to the flexibility of the system, this UV device can be used anywhere in the world, including in developing countries.

The use of UV lamps for the disinfection of wastewater presents many advantages such as lightness and portability, no formation of disinfection byproducts, low heat generation, and the potential for very low cost. These advantages make potential markets for UV treatment disinfection system vast and diverse. Moreover, the use of UV treatment would decrease the cost linked to waterborne diseases treatment while greatly improving the water quality.

### Example 5

### Spiral UV Lamps

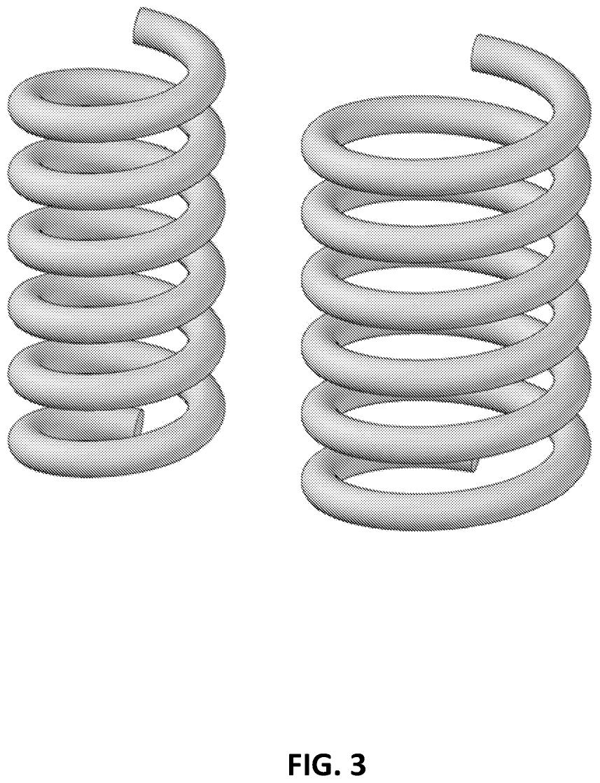

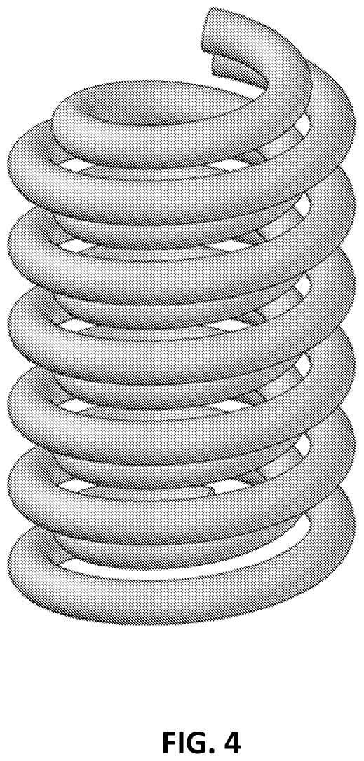

FIGS. 3 and 4 show an example of a spiral-shaped UV-lamp (UV light source) for the disinfection of a flowing water sample. In FIG. 3, the UV lamp is shown split into two, where the smaller spiral is dimensioned so as to fit into the larger spiral. FIG. 4 shows an example of a spiral UV-lamp device for the disinfection of a flowing water sample, where the smaller spiral is shown to fit into the larger spiral. The parameters of the present example are shown below (based on a bottle neck entrance being about 1.25″ or ˜31 mm diameter):
inner spiral diameter=13.5 mm;
outer spiral diameter=16.5 mm;
inner and outer coil are attached at the bottom;
electrical connections are at the top, vertical, parallel, or on opposite sides so that the lamp is held evenly;
number of spirals=can be two or more.

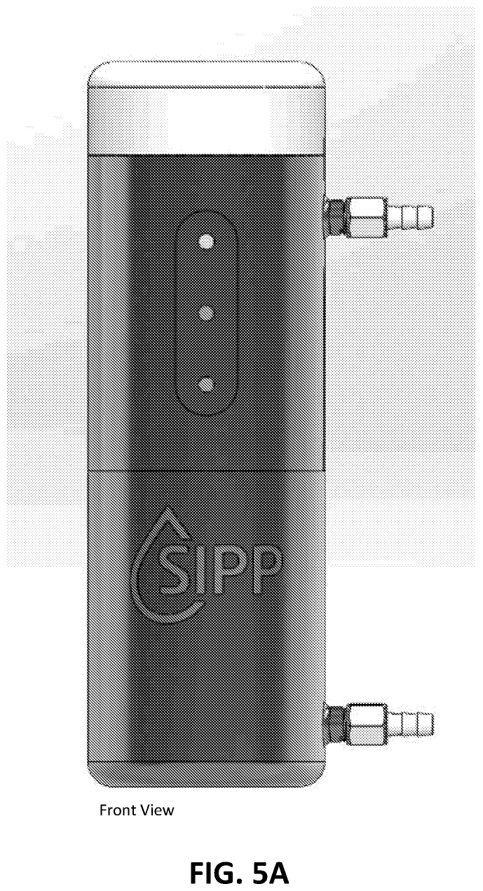

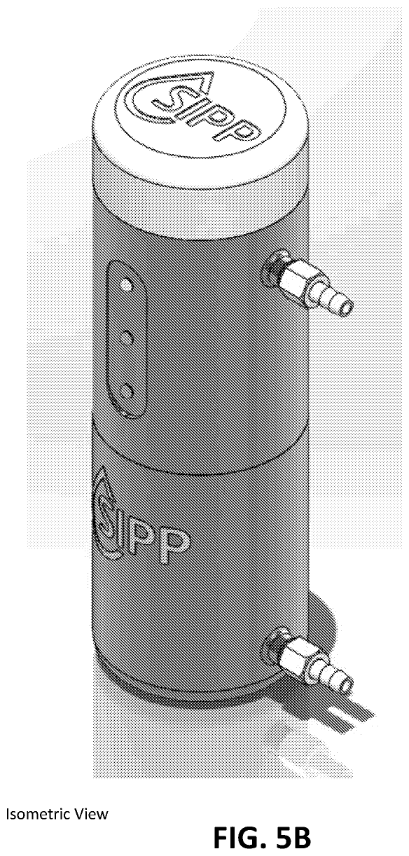

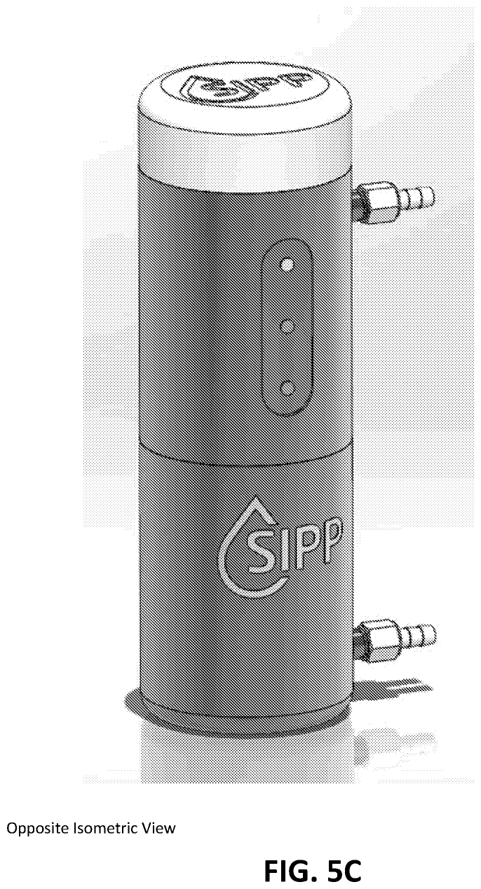

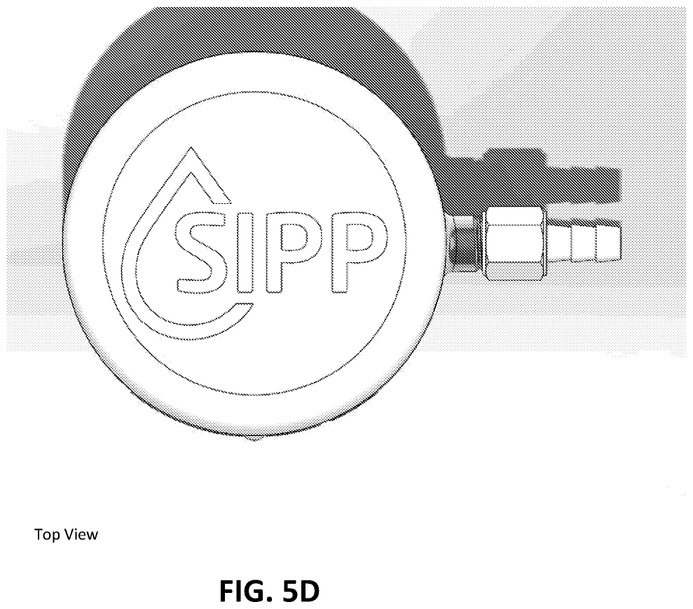

FIGS. 5A-5D are three-dimensional renderings of an device comprising a compact, modular, self-contained ultraviolet device for the inactivation of a pathogen in a flowing water sample (as described herein and in US Patent Publication No. 2018/0105438, which is fully incorporated by reference), that further includes filtration and at least one processor, sensors and a communications interface in communication with the processor.

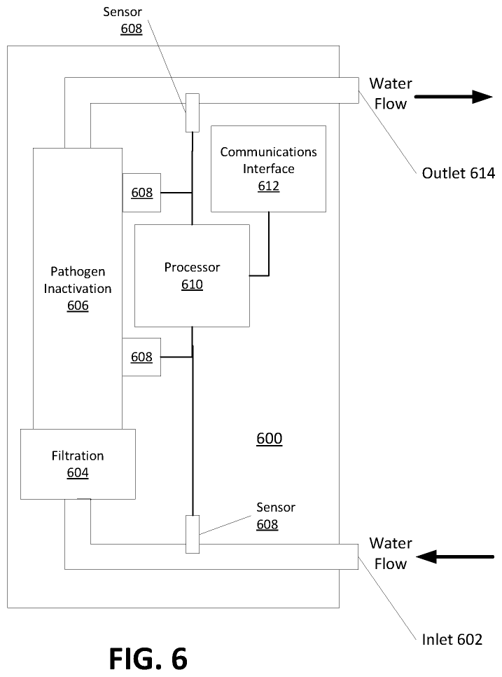

FIG. 6 is a block diagram of the device shown in FIGS. 5A-5D. The device 600 comprises an inlet 602 for water flow, a filtration section 604, a pathogen inactivation chamber 606 for disinfection of the water, one or more sensors 608 that are in communication with a processor 610, a communications interface 612 that is in communications with the processor and allows the device 600 to send and/or receive information and/or signals over a network, and an outlet 614 for water flow. The described embodiments of the device 600 are sufficiently compact to connect to a water outlet (faucet, refrigerator, etc.) in a home, business or other location of potable water usage. The sensors 608 can be one or more sensors that sense, for example, water quality indicators, flow rate, purification/contaminants, water pressure, and the like. The water quality indicators that can be sensed include turbidity, disinfection by-products, radiological parameters, organic and/or inorganic chemical contaminants, and the like. For example, sensed inorganic chemicals may include antimony, arsenic, asbestos, barium, beryllium, cadmium, chromium, copper, cyanide, fluoride, lead, mercury, nitrate, nitrite, selenium, thallium, and the like. Sensed disinfection by-products may include chlorine, chloramines, chlorite, chlorine dioxide, bromate, total organic carbon, total trihalomethanes, haloacetic acids, and the like. Sensed radiological parameters may include beta/photon emitters, alpha emitters, combined radium, uranium, and the like. Sensed organic chemicals may include 2,4-D, 2,4,5-TP(Silvex), acrylamide, alachlor, atrazine, benzo(A)pyrene, carbofuran, chlordane, dalaopon, di(2-ethylhexyl)adipate, di(2-ethylhexyl)phthalates, dinoseb, diquat, dioxin(2,3,7,8-TCDD), endothall, endrin, epichlorhydrin, glyphosate, heptachlor, heptachlor epoxide, hexachlorobenzene, hexachlprocyclopentadiene, lindane, methoxychlor, oxamyl (vydate), PCB's, pentachlorophenol, picloram, simazine, toxaphene, benzene, carbon tetrachloride, chlorobenzene, dibromochlorpropane, o-dichlorobenzene, p-dichlorobenzene, 1,2-di chloroethylene, trans-1,2-dichloroethylene, dichloromethane, 1,2-dichloropropane, ethylbenzene, ethylene dibromide, styrene, tetrachloroethylene, 1,2,4-trichlorbenzene, 1,1,1-trichlorethane, 1,1,2-trichloroethane, trichloroethylene, toluene, vinyl chloride, xylenes, and the like. Though not shown in FIG. 6, the device may further comprise a power source that provides electrical energy to the processor 610, communications interface 612, sensors 608, and other components, as needed. The power source may be an on-board power source such as a battery, which can be a rechargeable battery or a disposable battery. Or, the power source can be an externally-connected AC source, which can be stepped-down in voltage and/or converted to DC, as needed, and the like. In some instances, if the communications interface 612 is connected to a wired network, the wired network and communications interface 612 can be used to supply power to the device 600. In various configurations, the communications interface 612 can be used to communicate over wired (including fiber optic) and/or wireless networks. For example, the communications interface 612 may be configured to communicate using wireless short-range communications technology standards such as Bluetooth, Zigbee and the like, and/or over a WAN, LAN, or WLAN, which includes any version of the Wi-Fi IEEE 802.11 protocol; it may be configured to communicate using cellular technology and protocols; using power line carrier, and the like.

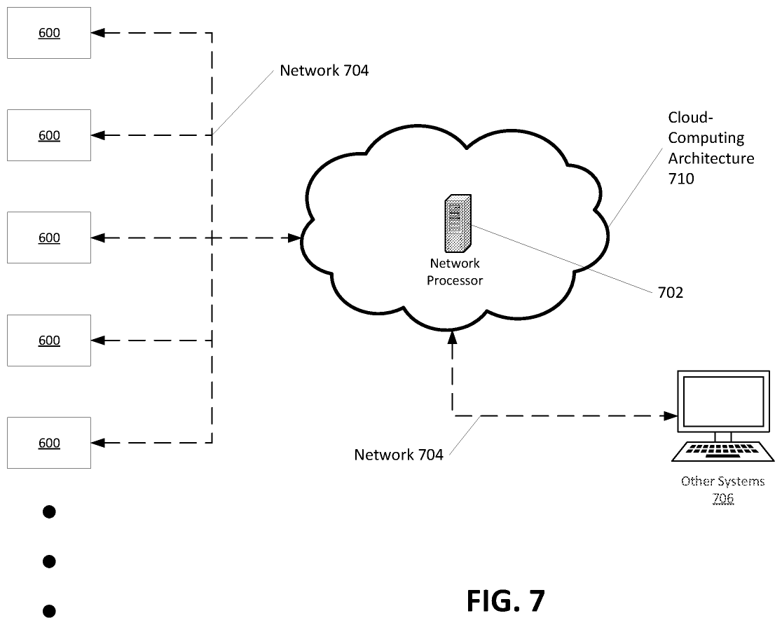

FIG. 7 is an illustration of a system comprised of one or more of the devices 600, as described above, where each device 600 is installed and connected to a water outlet (faucet, refrigerator, etc.) in a home, business or other location of potable water usage. In various configurations, a plurality of devices may be installed in a plurality of homes, businesses, etc., and/or a plurality of the devices 600 may be installed in a single home, business, etc. Each of the installed devices 600 are in communication with one or more network processors 702 over a network 704. In some instances, the network processor 702 may comprise all or part of a cloud-computing architecture 710. In FIG. 7 dashed lines are used to show the network as 704 as the network 704 may be wired (including fiber optic), wireless, or combinations thereof. Communications between each of the devices 600 and the network processor 702 are generally bi-directional, though in some instances communications may be uni-directional. Data and/or signals, including data collected by the sensors 608 are transmitted from the one or more devices 600 over the network 704 to the network processor 702. Similarly, data and/or signals may be transmitted from the network processor 702 over the network 704 to the one or more devices 600. The network processor 702 can be used to perform data analytics, provide alarms (regarding clogged filter, water purification, low water pressure, high water pressure, unexpected water flow, etc.), and the like. In some instances, the network processor 702 may be in communication with other systems 706. For example, data and/or signals, including data collected by the sensors 608 received from the one or more devices 600 over the network 704 by the network processor 702 may be used to perform functions through other systems 706 such as controlling all or parts of a water treatment facility, control valves, regulate water pressure, etc. of water distribution system, order replacement parts for water treatment/filtration device, and the like. For example, data collected can be used to initiate a replacement part shipment. Some examples of replacement parts could be a new filter or a new UV lamp for one or more of the devices 600. In another example, data collected could be used to help guide an organizations' or city's infrastructure renovation efforts such as water distribution pipes. In yet another non-limiting example, messages or alerts could be issued to citizens or app users based on collected and analyzed data. For example, an alert concerning leak detection or a faucet that failed to shut off could be sent to the end user. In other examples, a real time dispatch of repairmen could be made based upon a change in monitored metrics (e.g., drop in flow or pressure, and the like). The repairmen could be instantly directed to the location thus saving time, money, and resources. In some instances, the device could help detect the presence of chemicals and help to narrow down the exact geographical source. In other instances, the device can provide a real time snapshot of water usage to help the utility and treatment organizations make better estimations on operational metrics.

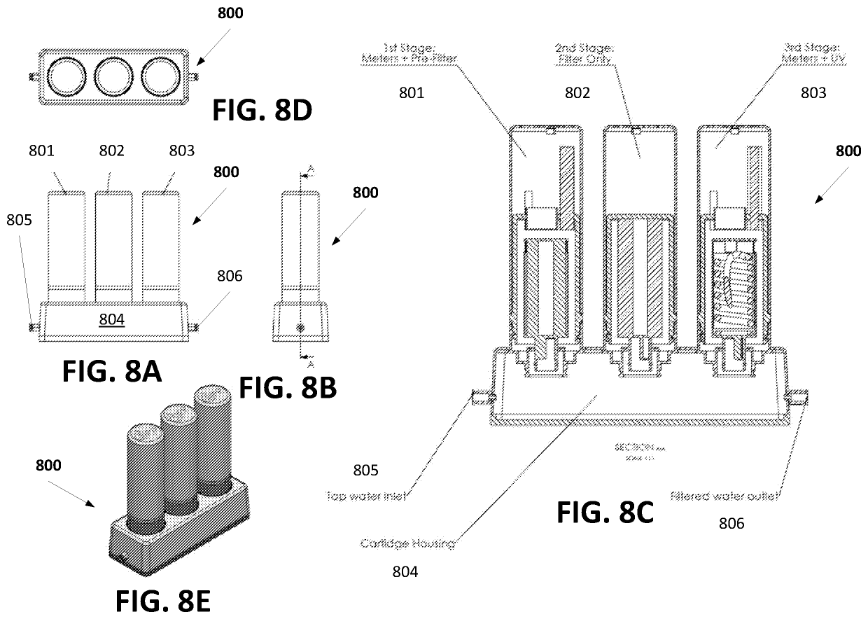

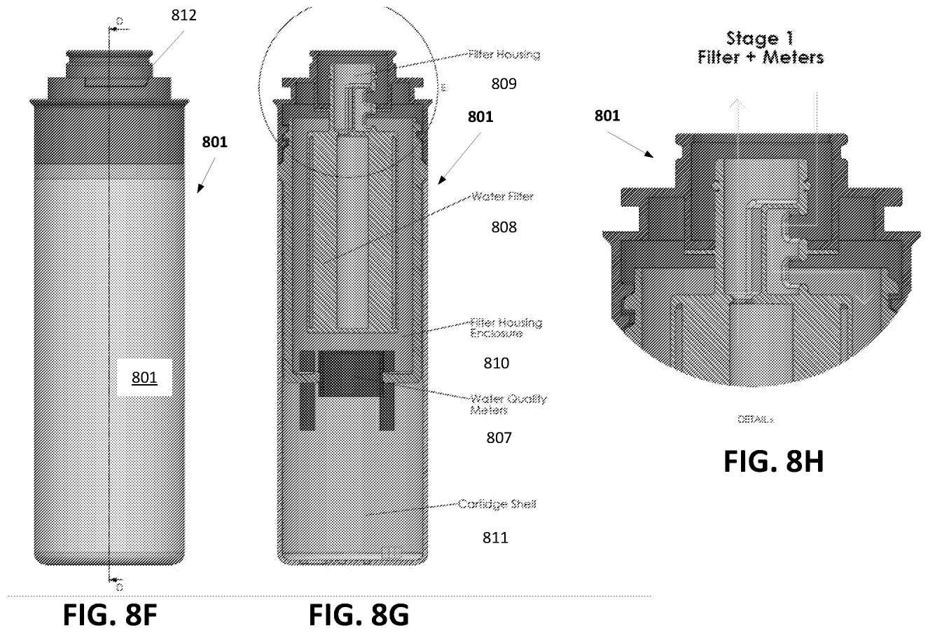

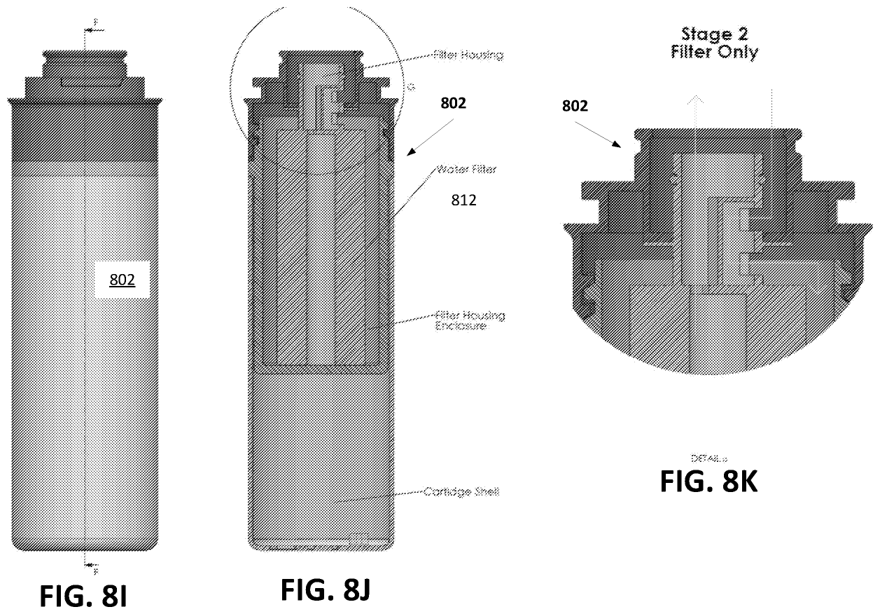

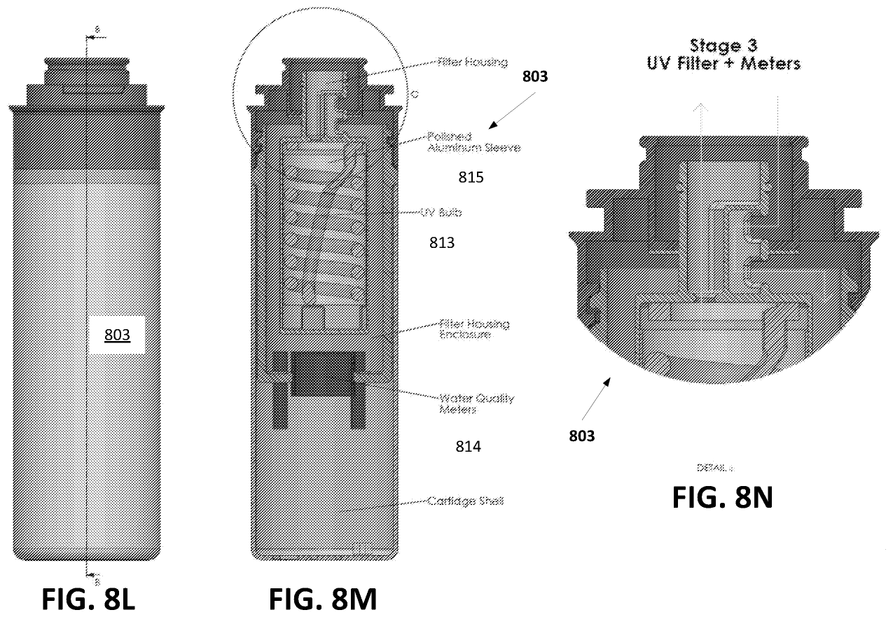

FIGS. 8A-8N illustrate an exemplary embodiment of a compact, modular, self-contained ultraviolet device 800 for the inactivation of a pathogen in a flowing water sample and filtering comprised of multiple stages and having replaceable components. The device 800 is comprised of a plurality of replaceable and interchangeable cartridges. The exemplary device is designed in a modular fashion to accommodate varying degrees of water treatment and monitoring of a flowing water sample. While the shown example has three openings that allow for quick attachment of cartridges that can treat the water or take quality readings on it, other embodiments contemplated within the scope of this disclosure may have more or fewer openings/cartridges. The forms of treatment possible within the cartridges include disinfection (e.g., via ultraviolet (UV) light) and filtration. Furthermore, water may be monitored and/or analyzed including capturing quality monitoring metrics such as pH, turbidity, Total Dissolved Solids (TDS), flow, temperature, and the like.

Referring to FIG. 8A, which is a plan view of the exemplary embodiment comprised of multiple cartridges 801, 802, 803 a housing 804, a water inlet 805, and a water outlet 806, each of the shown cartridges 801, 802, 803 can be used interchangeably to provide optimal water treatment and optimize data collection. Within the cartridge 801cartridge 801, 802, 803 itself, the contents are interchangeable to allow the cartridges 801, 802, 803 to be used with all parts together or independently. Each cartridge 801cartridge 801, 802, 803 is capable of housing at least one of a sensor group of the aforementioned sensors, a water filter, and a UV light. Each cartridge 801cartridge 801, 802, 803 is configured to handle standard water pressure and connect to the underlying circuitry at the base housing 804 of the device to provide sensor power and connectivity to the sensors.

FIGS. 8A-8E illustrate several views of the exemplary device. FIG. 8A is a front elevation view and FIG. 8B is a side elevation view showing Section A-A, which is illustrated in FIG. 8C. FIG. 8D is a top down view of the device 800 comprised of three cartridges 801, 802, 803 loaded into the housing 804 to form an embodiment of the device 800. FIG. 8E is a perspective view of the device 800 having three cartridges 801, 802, 803 loaded into the housing 804.

FIG. 8C shows a cut view of the exemplary device 800 with a typical (but non-limiting) setup of the three cartridges 801, 802, 803. It also shows the influent (in-flow) of the water at the inlet 805 and effluent (out-flow) of the water at the outlet 806. In this exemplary embodiment, the first cartridge 801 is comprised of a sensor pod 807 (refer to FIGS. 8F-8H) to measure the influent water. It quick connects (see FIG. 8H) to the cartridge housing 804, which contains the necessary circuitry, power supply, and WiFi and Bluetooth antennae for communicating with connected networks to transmit pertinent data,. In this particular non-limiting embodiment, the first cartridge 801 further includes an optional water filter 808 (e.g., a pre-filter). The first cartridge 801 is further comprised of a filter housing 809, a filter housing enclosure 810 and a cartridge shell 811. FIG. 8F is an image of the outer casing or cartridge shell 811 of the first cartridge 801. It also shows the quick connect threads 812 of the cartridge 801. FIG. 8G is a cut through illustration of the first cartridge 801. It shows the sensor pod's probes 807 as well as how an optional filter 808 interfaces with the probes 807. FIG. 8H is a close up view of the connection of the cartridge 801. It details the quick connect threads 812 as well as the water flow in and out of the cartridge 801 itself.

The second cartridge 802 in this exemplary embodiment 800 comprises a water filter 812 (refer to FIGS. 8I-8K). The filter 812 could be a carbon filter, RO filter, or other filtration mechanism used for removing contaminants from a flowing water sample. FIG. 81 shows an exterior view of the cartridge 802. FIG. 8J shows a view of only a filter 812 in the cut-through, and FIG. 8K shows a close up of the quick connect thread and the water flow in and out of the cartridge. Water flows into the cartridge to the outside of the filter 812 and then inward radially and out through the center.

The third cartridge 803 in this exemplary embodiment 800 comprises a UV light source 813 to disinfect the water (refer to FIGS. 8L-8N). Additionally, in this exemplary embodiment the third cartridge 803 also comprises a sensor pod 814 to measure the quality of the effluent water (after filtering and treatment). FIG. 8L illustrates an exterior view of the cartridge 803. FIG. 8M is a cut-through illustration that shows the cartridge 803 with the sensor pod 814 and a UV disinfection reactor comprised of an ultraviolet bulb 813 in a polished aluminum cavity 815. The water flows up around the outside of the UV reactor then through slots that force the water down through the UV reactor. The sensor pod 814 includes sensors for capturing quality monitoring metrics such as pH, turbidity, Total Dissolved Solids (TDS), flow, temperature, and the like.

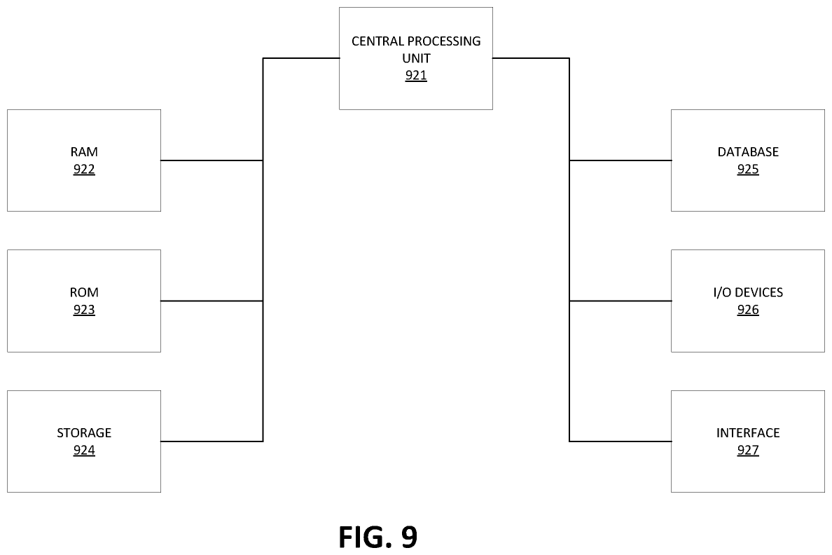

FIG. 9 illustrates an exemplary computer. Sensors 608, processor 610, communications interface 612, network processor 702 and/or the cloud computing architecture 710, as well as other system components, can include all or some of the components shown in FIG. 9.

The computer may include one or more hardware components such as, for example, a central processing unit (CPU) 921, a random-access memory (RAM) module 922, a read-only memory (ROM) module 923, a storage 924, a database 925, one or more input/output (I/O) devices 926, and an interface 927. Alternatively and/or additionally, the computer may include one or more software components such as, for example, a computer-readable medium including computer executable instructions for performing a method associated with the exemplary embodiments. It is contemplated that one or more of the hardware components listed above may be implemented using software. For example, storage 924 may include a software partition associated with one or more other hardware components. It is understood that the components listed above are exemplary only and not intended to be limiting.

CPU 921 may include one or more processors, each configured to execute instructions and process data to perform one or more functions associated with a computer for monitoring water treatment and flow. CPU 921 may be communicatively coupled to RAM 922, ROM 923, storage 924, database 925, I/O devices 926, and interface 927. CPU 921 may be configured to execute sequences of computer program instructions to perform various processes. The computer program instructions may be loaded into RAM 922 for execution by CPU 921.

RAM 922 and ROM 923 may each include one or more devices for storing information associated with operation of CPU 921. For example, ROM 923 may include a memory device configured to access and store information associated with the computer, including information for identifying, initializing, and monitoring the operation of one or more components and subsystems. RAM 922 may include a memory device for storing data associated with one or more operations of CPU 921. For example, ROM 923 may load instructions into RAM 922 for execution by CPU 921.

Storage 924 may include any type of mass storage device configured to store information that CPU 921 may need to perform processes consistent with the disclosed embodiments. For example, storage 924 may include one or more magnetic and/or optical disk devices, such as hard drives, CD-ROMs, DVD-ROMs, or any other type of mass media device.

Database 925 may include one or more software and/or hardware components that cooperate to store, organize, sort, filter, and/or arrange data used by CPU 921. For example, database 925 may store data relating to monitoring water treatment and flows, associated metadata, and health or quality information. It is contemplated that database 925 may store additional and/or different information than that listed above.

I/O devices 926 may include one or more components configured to communicate information with a user associated with the device shown in FIG. 9. For example, I/O devices 926 may include a console with an integrated keyboard and mouse to allow a user to maintain a historical database of information, update associations, and access digital content. I/O devices 926 may also include a display including a graphical user interface (GUI) for outputting information on a monitor. I/O devices 926 may also include peripheral devices such as, for example, a printer for printing information associated with the computer, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 927 may include one or more components configured to transmit and receive data via a communication network, such as the Internet, a local area network, a workstation peer-to-peer network, a direct link network, a wireless network, or any other suitable communication platform. For example, interface 927 may include one or more modulators, demodulators, multiplexers, demultiplexers, network communication devices, wireless devices, antennas, modems, and any other type of device configured to enable data communication via a communication network.

Any combination of one or more computer readable medium(s) may be utilized. The computer readable medium may be a computer readable signal medium or a computer readable storage medium. A computer readable storage medium may be, for example, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer readable medium may be transmitted using any appropriate medium, including but not limited to wireless, wireline, optical fiber cable, RF, etc., or any suitable combination of the foregoing.

Computer program code for may be written in any combination of one or more programming languages, including an object-oriented programming language such as Java, Javascript, Python, Smalltalk, C++, or the like, and conventional procedural programming languages, such as the “C” programming language or similar programming languages. The program code may execute entirely on the computing unit.

It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

While this specification contains many specific implementation details, these should not be construed as limitations on the claims. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein. It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A device for treatment and monitoring of a flowing water sample, the device comprising:
a filtration section for filtering the flowing water sample;
a pathogen inactivation chamber for disinfection of the flowing water sample, wherein the pathogen inactivation chamber comprises:
a housing container, wherein the housing container comprises a highly reflective cavity,
an ultraviolet lamp, wherein the ultraviolet lamp is comprised within the housing container, and
an entry point and exit point for a flowing water sample, wherein the flowing water sample is in direct contact or in close contact with the ultraviolet lamp, wherein the ultraviolet lamp delivers ultraviolet light rays both radially inward and outward; and
a processor;
one or more sensors in communication with the processor; and
a communications interface in communication with the processor.

2. The device of claim 1, wherein the one or more sensors sense flow rate, water quality indicators, and/or temperature.

3. The device of claim 2, wherein the water quality indicators that can be sensed include one or more of turbidity, disinfection by-products, radiological parameters, organic and/or inorganic chemical contaminants.

4. The device of claim 1, wherein the communications interface is configured to communicate over wired (including fiber optic) and/or wireless networks or combinations thereof, including communicating using wireless short-range communications technology standards and/or over a WAN, LAN, WLAN, which includes any version of the Wi-Fi IEEE 802.11 protocol; configured to communicate using cellular technology and protocols; or configured to communicate using power line carrier.

5. The device of claim 4, further comprising a network processor, wherein the device is in communication with the network processor through the network.

6. The device of claim 5, wherein data and/or signals, including data collected by the one or more sensors are transmitted from the device over the network to the network processor and/or data and/or signals are transmitted from the network processor over the network to the device.

7. The device of claim 5, wherein the network processor is used to perform data analytics, and/or provide alarms regarding clogged filter, water purification, low water pressure, high water pressure, or unexpected water flow.

8. The device of claim 7, wherein data and/or signals, including data collected by the sensors received from the one or more devices over the network by the network processor are used to perform functions through other systems such as controlling all or parts of a water treatment facility, control valves, regulate water pressure of a water distribution system, and order replacement parts for water treatment/filtration device including initiating a replacement part shipment for the device.

9. The device of claim 8, wherein data and/or signals are used by the network processor to guide an organization's or city's infrastructure renovation efforts such as water distribution pipes; generate messages or alerts to citizens or app users based on collected and analyzed data; real time dispatch of repairmen made based upon a change in monitored metrics, wherein the repairmen are instantly directed to the location thus saving time, money, and resources; detect the presence of chemicals and narrow down the exact geographical source; and provide a real time snapshot of water usage to allow the utility and treatment organizations make better estimations on operational metrics.

10. The device of claim 1, wherein the device is comprised of a plurality of replaceable and interchangeable cartridges housing one or more filters, the pathogen inactivation chamber, and the one or more sensors.

11. A method for treatment and monitoring of a flowing water sample, comprising:
subjecting a flowing water sample to a device, the device comprising:
a filtration section for filtering the flowing water sample;
a pathogen inactivation chamber for disinfection of the flowing water sample, wherein the pathogen inactivation chamber comprises:
a housing container, wherein the housing container comprises a highly reflective cavity,
an ultraviolet lamp, wherein the ultraviolet lamp is comprised within the housing container, and
an entry point and exit point for a flowing water sample, wherein the flowing water sample is in direct contact or in close contact with the ultraviolet lamp, wherein the ultraviolet lamp delivers ultraviolet light rays both radially inward and outward; and
a processor;
one or more sensors in communication with the processor; and
a communications interface in communication with the processor.

12. The method of claim 11, wherein the one or more sensors sense flow rate, water quality indicators, and/or temperature.

13. The method of claim 12, wherein the water quality indicators that can be sensed include turbidity, disinfection by-products, radiological parameters, organic and/or inorganic chemical contaminants.

14. The method of claim 11, wherein the communications interface is configured to communicate over wired (including fiber optic) and/or wireless networks or combinations thereof, including communicating using wireless short-range communications technology standards and/or over a WAN, LAN, WLAN, which includes any version of the Wi-Fi IEEE 802.11 protocol; configured to communicate using cellular technology and protocols; or configured to communicate using power line carrier.

15. The method of claim 14, wherein the device further comprises a network processor, wherein the device is in communication with the network processor through the network.

16. The method of claim 15, wherein data and/or signals, including data collected by the one or more sensors are transmitted from the device over the network to the network processor and/or data and/or signals are transmitted from the network processor over the network to the device.

17. The method of claim 15, wherein the network processor is used to perform data analytics, and/or provide alarms regarding clogged filter, water purification, low water pressure, high water pressure, or unexpected water flow.

18. The method of claim 17, wherein data and/or signals, including data collected by the sensors received from the one or more devices over the network by the network processor are used to perform functions through other systems such as controlling all or parts of a water treatment facility, control valves, regulate water pressure of a water distribution system, and order replacement parts for water treatment/filtration device including initiating a replacement part shipment for the device.

19. The method of claim 18, wherein data and/or signals are used by the network processor to guide an organizations' or city's infrastructure renovation efforts such as water distribution pipes; generate messages or alerts to citizens or app users based on collected and analyzed data; real time dispatch of repairmen made based upon a change in monitored metrics, wherein the repairmen are instantly directed to the location thus saving time, money, and resources; detect the presence of chemicals and narrow down the exact geographical source; and provide a real time snapshot of water usage to allow the utility and treatment organizations make better estimations on operational metrics.

20. The method of claim 11, wherein the device is comprised of a plurality of replaceable and interchangeable cartridges housing one or more filters, the pathogen inactivation chamber, and the one or more sensors.
